(19) United States
(12) Patent Application Publication
(10) Pub. No.: US 2013/0083347 A1
(43) Pub. Date: Apr. 4, 2013

(54) METHOD AND SYSTEM FOR PHYSICALLY SECURING A HOST DEVICE

(71) Applicants: Maria PEREZ, Half Moon Bay, CA (US); Deadre Anne Bruetsch, Castro Valley, CA (US)

(72) Inventors: Maria PEREZ, Half Moon Bay, CA (US); Deadre Anne Bruetsch, Castro Valley, CA (US)

(73) Assignee: Konica Minolta Laboratory U.S.A., Inc., San Mateo, CA (US)

(21) Appl. No.: 13/248,551

(22) Filed: Sep. 29, 2011

(51) Int. Cl. G06K 15/02

(52) U.S. Cl. 358/1.14

(57) ABSTRACT

A method for physically securing a first host device upon a detection of a change in an external environment. The method includes initializing the first host device, the first host device having an application, which performs the following steps: creates a neighbor cache table for monitoring a network connection between the first host device and one or more second host devices; monitors the external network connections between the first host device and the one or more second host devices; and upon determining a change in an external environment between the host device and the one or more second host devices, securing the host device from processing jobs and/or requests from the one or more second host devices.

### FIELD OF THE INVENTION

The present invention relates to a method and system for physically securing an image forming apparatus, and more particularly to physically securing host devices such as image forming apparatuses by using IPv4 address resolution protocols (ARP) and/or IPv6 neighbor discovery protocols when connected to an IPv4 and/or IPv6 network connection and/or physically connected via a USB network connection.

### BACKGROUND OF THE INVENTION

Networks have enhanced our ability to communicate and access information by allowing one personal computer to communicate over a network (or network connection) with another personal computer and/or other networking devices, using electronic messages. When transferring an electronic message between personal computers or networking devices, the electronic message will often pass through a protocol stack that performs operations on the data within the electronic message (e.g., packetizing, routing, flow control).

The first major version of addressing structure, Internet Protocol Version 4 (IPv4), is still the dominant protocol of the Internet, although the successor, Internet Protocol Version 6 (IPv6) is being deployed actively worldwide. The IPv6 network protocol provides that IPv6 hosts or host devices (e.g., image forming apparatuses and other devices) can configure themselves automatically (i.e., stateless address autoconfiguration) when connected to an IPv6 network using ICMPv6 neighbor discovery messages (i.e., Neighbor Discovery Protocol or NDP).

When first connected to an IPv4 network, an IPv4 host (or host device) uses the address resolution protocol (ARP) to send and receive packets of data from one host to another host. Alternatively, when a host (or host device) is first connected to an IPv6 network, the IPv6 host (or host device) sends a link-local multicast neighbor solicitation request advertising its tentative link-local address for double address detection (dad), and if no problem is encountered, the host uses the link-local address. The router solicitations are sent (or router advertisements are received depending on timing) to obtain network-layer configuration parameters, and routers respond to such a request with a router advertisement packet that contains network-layer configuration parameters.

In the IPv6 protocol, the generation of an IP address (or IPv6 address) for an image forming device or other apparatus/device is defined in RFC 2462, entitled “IPv6 Stateless Address Autoconfiguration.” The IPv6 stateless autoconfiguration utilizes several features in IPv6, including link-local addresses, multicasting, the Neighbor Discovery (ND) protocol, and the ability to generate the interface identifier of an address from an underlying data link layer address (or MAC ID). The IPv6 protocol provides a computer device or image forming apparatus the ability to generate a temporary address until it can determine the characteristics of the network it is on, and then create a permanent address it can use based on that information.

Pursuant to the ICMPv6 protocol, an Address Uniqueness test (or duplicate address detection or double address detection (DAD)) is used to test and to ensure that the address generated pursuant to the IPv6 protocol is not for some reason already in use on the local network. The device or apparatus sends a Neighbor Solicitation message using the Neighbor Discovery Protocol (NDP), and listens for a Neighbor Advertisement in response that indicates that another device is already using its link-local address; if so, either a new address must be generated, or autoconfiguration fails and another method must be employed. Assuming the uniqueness test passes, the device assigns the link-local address (i.e., Link-Local Address Assignment) to its IP interface. This address can be used for communication on the local network, however, it cannot be used on the wider Internet (or communication network), since link-local addresses are not routed.

The node next attempts to contact a local router for more information on continuing the configuration. This is done either by listening for Router Advertisement messages sent periodically by routers, or by sending a specific Router Solicitation to ask a router for information on what to do next. The router also provides direction to the node on how to proceed with the autoconfiguration. The router can tell the node that on this network “stateful” autoconfiguration is in use, and tell it the address of a DHCP server to use. Alternately, the router will tell the host how to determine its global Internet address.

Assuming that stateless autoconfiguration is in use on the network, the host will configure itself with its globally-unique Internet address after performing double address detection. This globally-unique address is generally formed from a network prefix provided to the host by the router, combined with the device's identifier as generated in the first step. In addition, when using the protocol stateless addressing (stateless autoconfiguration) for IPv6, which is required by the IPv6 Ready Logo Program, the link-local addresses and global addresses are determined by concatenating an identifier unique to the adapter. Thus, when a MAC address broadcast is sent out, each network interface card on the local area network will see the broadcast address and automatically pass the information up to the upper layers of the OSI model (Open Systems Interconnection model).

With the existence of IPv4, USB and the implementation of IPv6 networks, it would be desirable to add security options to a host and/or host device having IPv4 and/or IPv6 capabilities by including a software module or software application associated with a computer device and/or a host device, and which uses IPv4 address resolution protocols (ARP) and/or IPv6 neighbor discovery protocols to physically secure the computer device or host device when connected to an IPv4 and/or IPv6 network connection, or physically connected via a USB network connection.

### SUMMARY OF THE INVENTION

In consideration of the above issues, a software module or software application associated with a computer device or host device such as an image forming apparatus, which uses a neighbor cache table to monitor external network configuration to physically secure a hosts device including image forming apparatuses and/or multifunctional printers.

In accordance with an exemplary embodiment, a method for physically securing a first host device, the method comprises: initializing the first host device, the first host device having an application, which performs the following steps: creates a neighbor cache table for monitoring a network connection between the first host device and one or more second host devices; monitors the external network connections between the first host device and the one or more second host devices; and upon determining a change in an external environment between the host device and the one or more second host devices, securing the host device from processing jobs and/or requests from the one or more second host devices.

In accordance with another exemplary embodiment, a system for physically securing a first host device from one or more second host devices, the system comprises: a first host device, the first host device an application, which creates a neighbor cache table for monitoring network connections between the first host device and the one or more second host devices; monitors the external network connections between the first host device and the one or more second host devices; and upon determining a change in an external environment between the first host device and the one or more second host devices, securing the first host device from processing jobs and/or requests from the one or more second host devices.

In accordance with a further exemplary embodiment, a computer program product comprising a non-transitory computer usable medium having a computer readable code embodied therein for physically securing a first host device, the computer readable code configured to cause the first host device to execute a process for an application that physically secures the first host device, the process comprises: initializing the first host device, the first host device having an application, which performs the following steps: creates a neighbor cache table for monitoring a network connection between the first host device and one or more second host devices; monitors the external network connections between the first host device and the one or more second host devices; and upon determining a change in an external environment between the first host device and the one or more second host devices, securing the first host device from processing jobs and/or requests from the one or more second host devices.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an illustration of a network system with a network communication protocol in accordance with an exemplary embodiment.

FIG. 2 is an illustration of a network stack having an application for filtering data packets in accordance with another exemplary embodiment.

FIG. 3 is an illustration of a network system having a first host device and one or more second host devices.

FIG. 4 is a flow chart showing an exemplary embodiment of a method for physically securing a host device.

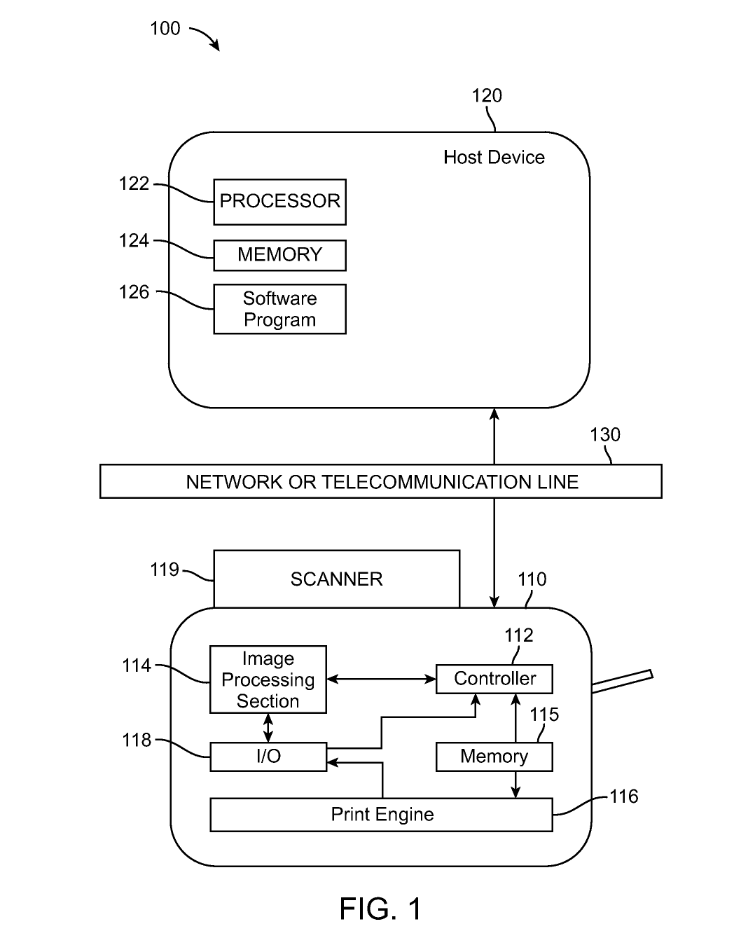

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The methods described herein can be implemented in an image forming system 100 that includes a first host device 110 preferably in the form of an image forming apparatus or multi-function peripheral (MFP) connected to one or more second hosts or host devices 120. Alternatively, the one or more second host devices 120 can be a router, server and/or other networking device, which transfers data via a network connection 130. In accordance with an exemplary embodiment, the first host device 110 may be embodied by a printer, a multi-function peripheral (MFP) and other known image forming apparatuses, which prints an image on a printing medium (or a recording medium) such as a sheet of paper based on printing data generated by the one or more second hosts 120. In accordance with an exemplary embodiment, the first host device 110 is a Multi-Function Peripheral (MFP), which includes at least a copy function, an image reading function, and a printer function, and forms an image on a sheet based on a print job (print instruction) sent from the one or more second hosts 120, image data read by an image reading section, such as a scanner, provided in the first host device 110, or the like.

In accordance with an exemplary embodiment, the one or more second hosts 120 is embodied by a personal computer or computer system, which generates and transmits printable data usable in the host device 110. An example of the one or more second hosts 120 may include a computer and/or a portable device such as a notebook personal computer, a cellular phone and a personal digital assistant (PDA). The one or more second hosts 120 can be a plurality of personal computers, and has the function of sending a print job to the host device 110 in the form of an image forming apparatus. In accordance with an exemplary embodiment, a printer driver program (hereinafter, sometimes simply referred to as a printer driver) is installed on the one or more second hosts 120, and the one or more second hosts 120 uses the function of the printer driver to generate a print job including the data of print conditions to be applied at the time of image formation, image data, and the like, and to send the generated print job to the host 120 in the form of an image forming apparatus.

In accordance with an exemplary embodiment, wherein the one or more second hosts 120 is a computer device and host device 110 is an image forming apparatus, the one or more second hosts 120 includes a processor 122 and one or more memories 124 for storing software programs 126 and data (such as files to be printed). The host device 110 in the form of an image forming apparatus (or printer) typically includes a printer controller (or firmware) 112, an image processing section (or data dispatcher) 114, a memory section 115, a print engine 116, an input/output (I/O) section 118, and a scanner 119.

The controller 112 may include a central processing unit (CPU), a random access memory (RAM), and a read only memory (ROM). The controller 112 processes the data and job information received from the one or more second host devices 120 to generate a print image. The controller 112 also includes an operating system (OS), which acts as an intermediary between the software programs and hardware components within the image forming apparatus. The operating system (OS) manages the computer hardware and provides common services for efficient execution of various application software. In accordance with an exemplary embodiment, the controller 112 processes the data and job information received from the one or more second hosts 120 to generate a print image.

The image processing section 114 carries out various image processing under the control of the controller 112, and sends the processed print image data to the print engine 116. The image processing section 114 also includes a scanner section for optically reading a document, such as an image recognition system. The scanner section receives the image from the scanner and converts the image into a digital image. The print engine 116 forms an image on a recording sheet based on the image data sent from the image processing section 114. The I/O section performs data transfer with the one or more second hosts 120. The controller 112 is programmed to process data and control various other components of the image forming apparatus 120 to carry out the various methods described herein. The print engine 116 forms an image on a sheet of print medium (i.e., a recording sheet) based on the image data sent from the image processing section.

The input/output (I/O) port 118 provides communications between the printer section and the one or more second hosts 120 and receives page descriptions (or print data) from the host for processing within the host device 110. In accordance with an exemplary embodiment, the operation of printer section commences when it receives a page description from the one or more second hosts 120 via I/O port 118 in the form of a print job data stream and/or fax data stream. The page description may be any kind of page description languages (PDLs), such as PostScript® (PS), Printer Control Language (PCL), Portable Document Format (PDF), and/or XML Paper Specification (XPS).

The one or more second hosts 120 and first host device 110 are preferably connected to each other through a network connection 130, which can be a USB connection, an IPv4 communication network, and/or an IPv6 communication network in a state capable of performing data communications. In accordance with an exemplary embodiment, the networking device and the host devices 110, 120 can be any network device, which supports an USB, IPv4 and/or an IPv6 communication protocol. Examples of communication networks 130 consistent with embodiments of the invention include, but are not limited to, the Internet, an Intranet, a local area network (LAN) and a wide area network (WAN). The one or more second hosts 120 and the host device 110 can be connected with a wire or can be connected with a wireless connection by using radio frequency (RF), infrared (IR) transmission, USB, IEEE1394 and/or other suitable wireless technology.

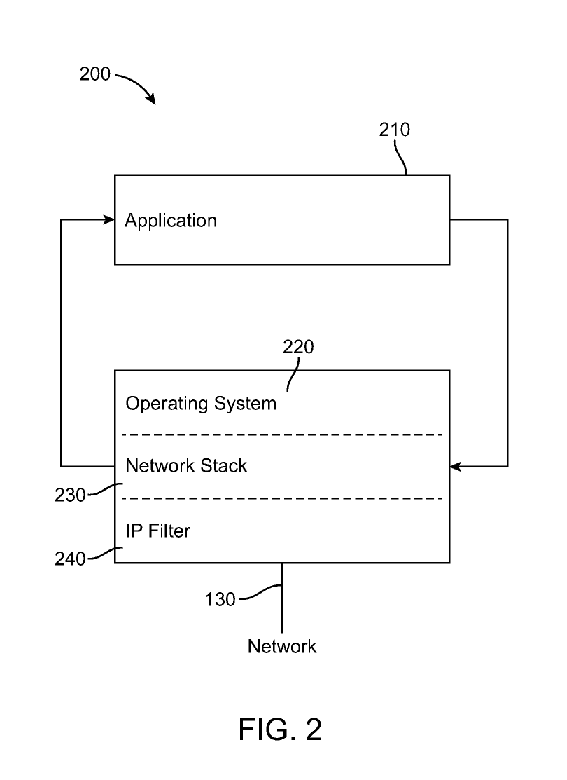

FIG. 2 is an illustration of a network stack for a host device (or first host device) 200 having an application (or software module) 210 for creating a neighbor cache table for monitoring external network connections between the host device and at least one second host devices. As shown in FIG. 2, the host device 200 has an application (or software module) 210 and an IP filter (or packet capture filter) 240, which captures (or intercepts) outgoing and incoming data packets having neighbor solicitation and/or neighbor advertisement requests pursuant to the IPv6 protocol. As shown in FIG. 2, the application 210 is preferably an application level module, which is configured to create a neighbor cache table to monitor external network connections between the host device 200 and at least one second host devices (not shown). In accordance with an exemplary embodiment, the application 210 can be part of the printer driver and/or firmware of a host device, such as a personal computer and/or multifunctional printer, a separate application or software module, or part to the operating system of the host device.

In accordance with an exemplary embodiment, the IP filter 240 forwards the incoming or outgoing packet having a neighbor solicitation or neighbor advertisement packet (or package) to the application 210, which logs or creates a neighbor cache table of external connections between the host device 200 and at least one second host devices. In accordance with an exemplary embodiment, the application's 210 functionality also can be enabled or disabled at will by a network administrator or other designated individual.

The host device 200 includes an operating system 220 (OS), which acts as an interface between the device's hardware and application programs, and which is also responsible for the management and coordination of activities and the sharing of the resources within host devices. In accordance with an exemplary embodiment, the application 210 runs on the operating system 220 of the computer device (or node), and the network layer is under or a part of the operating system 220. By utilizing an application 210 as described herein, the operating system of the host device 200 does not need to be altered or changed in anyway.

In accordance with an exemplary embodiment, a neighbor solicitation request is generated on the host device 200 having an application or software module 210, which creates a neighbor cache table for monitoring network connections between the host device and one or more second host devices. The application 210 monitors the external network connections between the host device 200 and the one or more second host devices. Upon determining a change in an external environment between the host device 200 and the one or more second host devices, the software module 210 secures the host device from processing jobs and/or requests from the one or more second host devices.

In accordance with an exemplary embodiment, the neighbor solicitation request is sent with the at least one security option from the first node pursuant to IPv6 protocol to the at least one second device. The neighbor solicitation request is received by the one or more second host devices and in return sends a neighbor advertisement to the host device 200, which is received by the software application 210, which generates the neighbor cache table for monitoring a network connection between the host device and one or more second host devices. The software module 210 monitors the external network connections between the host device and the one or more second host devices; and upon determining a change in an external environment between the host device and the one or more second host devices, the software module will secure the host device from processing jobs and/or requests from the one or more second host devices.

In accordance with an exemplary embodiment, the change in the external environment between the host device and the one or more second host devices preferably includes at least one of the following: a change in the external environment, wherein the change in the external environment is an unavailability of one or more of the one or more second host devices; a change in one or more default routers, DHCP server, DNS server, a change in network prefix, a change in an addressing method, and/or a change of an IP address of the one or more second host devices.

In the IPv6 protocol, the software module 210 uses the neighbor discovery protocol to create the neighbor cache table and detect changes in the external environment. In addition, the neighbor cache table can be updated by monitoring neighbor discovery message activities. The software module 210 can also initiate neighbor solicitation messages to verify a veracity of the neighbor cache table independently of neighbor discovery timing.

Upon detecting the change in the external environment, the software module 210 can require an administer and/or operator to unlock the host device 200. In accordance with an exemplary embodiment, host devices 200, which are new, i.e., from the factory, can have the feature and/or software module enabled by default. The act of enabling the feature as described herein for physically securing a host device preferably clears any physical location information stored in the host device. Once the host device is enabled, the host device initiates monitoring of the network connection and the one or more second host devices on the network to determine a physical location of the host device.

In accordance with an alternative embodiment, the network connection between the host device and the one or more second host devices is an IPv4 network connection. If the network connection is an IPv4 network connection, the software module can use ARP (address resolution protocol) messages to create the cache table, which monitors the network connection between the host device and one or more second host devices.

In a further embodiment, the network connection between the host device and the one or more second host devices is an USB connection. For USB connections, the one or more second host devices are preferably a computer having a printer driver, and wherein a PJL (printer job language) generated by the printer driver has a CPU specific ID (identifier). If the host device has seen the CPU specific ID, and a current CPU specific ID do not match, securing the host device from processing jobs and/or requests from the one or more second host devices.

In accordance with an exemplary embodiment, the first host is an image forming apparatus, a computer and/or a host device, and the at least one second host is an image forming apparatus, an intermediary device, a router, and/or a personal computer. The host device 200 is preferably an image forming apparatus and the one or more second host devices is a computer device, and wherein the jobs and/or requests from the one or more second host devices are print jobs. The host device 200 preferably displays a message on a graphical user interface of the host device upon rejecting jobs and/or requests from the one or more second host devices to indicate that the first host device needs to be reset and/or unlocked to accept further jobs and/or requests from the one or more second host devices. In accordance with an exemplary embodiment, upon detection of a change in the external environment, the host device 200 is preferably physically secured from accepting any jobs and/or requests from any of the one or more second host devices.

In accordance with an embodiment, an application running on a host device will obtain a copy of the neighbor cache table. The application 210 will continue or keep monitoring the network traffic by monitoring the neighbor discovery messages. Also, the application can initiate neighbor solicitation messages to verify the veracity of its table independently of neighbor discovery timing. In accordance with an exemplary embodiment, the application 210 can verify its table faster than the neighbor discovery timing algorithm but never slower than such an algorithm. If an extreme change in network configuration is detected, for example, if all neighbors (e.g., one or more second host devices) are no longer reachable, a change in default routers, DHCP server, DNS server, a change in network prefixes, a change in addressing method, or a change of address for one or more of the one or more second host devices, the application 210 will lock the printing/fax/scan capabilities of the host device 200 until a system administrator overrides the lock.

In accordance with an exemplary embodiment, the application 210 can have a networking policy, which assists with determining what external environmental changes will constitute an external change which secures the host device 200 from accepting print jobs and/or request from the one or more second host devices. For example, the networking policy can prioritize the one or more second host devices, which preferably includes networking device such as routers, bridges and switches. In accordance with an exemplary embodiment, for example, with an IPv6 network connection, a change in a router, DHCP server, and DNS server can be determined to be a change in the external environment. Alternatively, in an IPv4 network, a change in the DHCP, DNS and/or default router can be determined to be a change in the external environment. Alternatively, the policy can provide that if more than a certain percentage (e.g., 10 to 25%, greater than 25%, greater than 50%) of the one or more second devices are no longer have network connectivity with the first host device that a change in the external environment has occurred.

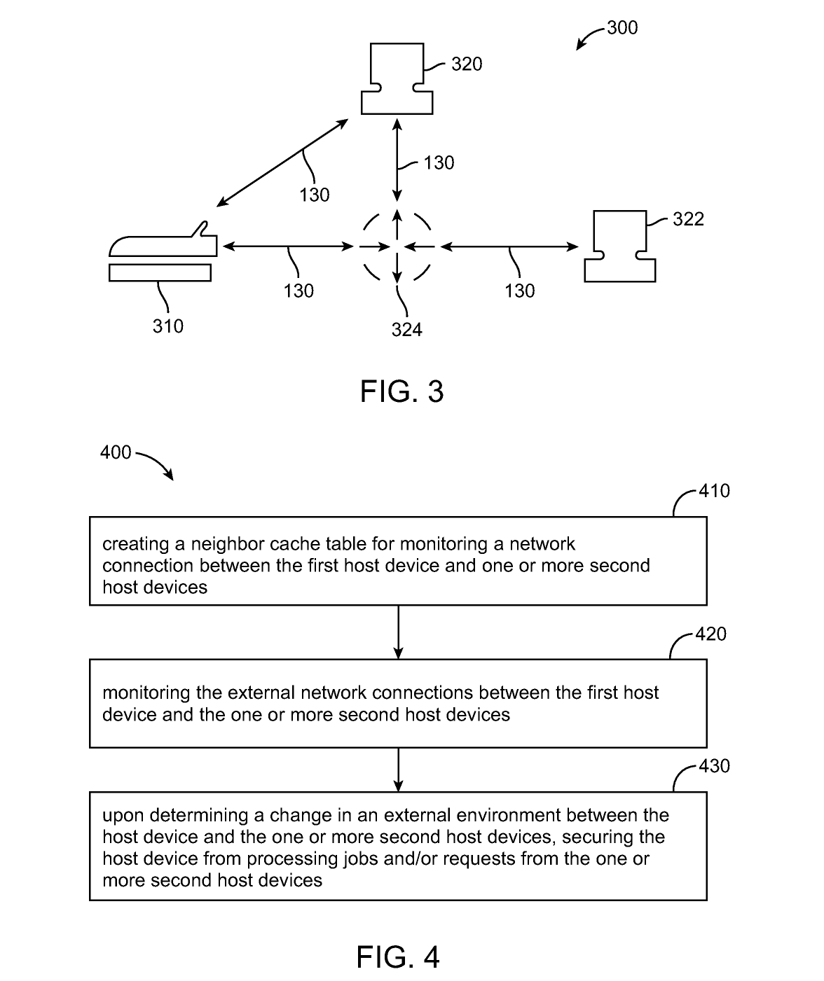

FIG. 3 is an illustration of a network system 300 having a first host device and one or more second host devices. As shown in FIG. 3, the network system 300 preferably includes a host device 310 in the form of an image forming apparatus 310 and one or more second host devices 320, 322, 324. For example, the one or more second host devices can be personal computers 320, 322, routers, bridges and/or switches 324, and/or other host devices and/or networking devices as described herein.

FIG. 4 is a flow chart showing an exemplary embodiment of a method for physically securing a first host device 400. In step 410, the first host device has an application, which creates a neighbor cache table for monitoring a network connection between the first host device and one or more second host devices. In step 420, the application monitors the external network connections between the first host device and the one or more second host devices. In step 430, upon determining a change in an external environment between the first host device and the one or more second host devices, the application physically secures the first host device from processing jobs and/or requests from the one or more second host devices.

A computer program product comprising a non-transitory computer usable medium having a computer readable code embodied therein for physically securing a first host device, the computer readable code configured to cause the first host device to execute a process for an application that physically secures the first host device, the process comprises: initializing the first host device, the first host device having an application, which performs the following steps: creates a neighbor cache table for monitoring a network connection between the first host device and one or more second host devices; monitors the external network connections between the first host device and the one or more second host devices; and upon determining a change in an external environment between the first host device and the one or more second host devices, securing the first host device from processing jobs and/or requests from the one or more second host devices.

The non-transitory computer usable medium, of course, may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for physically securing a first host device, the method comprising:
initializing the first host device, the first host device having an application, which performs the following steps:
creates a neighbor cache table for monitoring a network connection between the first host device and one or more second host devices;
monitors the external network connections between the first host device and the one or more second host devices; and
upon determining a change in an external environment between the host device and the one or more second host devices, securing the first host device from processing jobs and/or requests from the one or more second host devices.

2. The method of claim 1, wherein the change in the external environment between the first host device and the one or more second host devices includes at least one of the following:
an unavailability of one or more of the one or more second host devices;
a change in one or more default routers;
a change in DHCP server or DNS server;
a change in a network prefix of one or more of the second host devices;
a change in an addressing method of one or more of the second host devices; or p1 a change of an IP address of the one or more second host devices.

3. The method of claim 1, wherein the network connection between the first host device and the one or more second host devices is an IPv6 network connection.

4. The method of claim 3, further comprising using neighbor discovery to create the neighbor cache table and detect changes in the external environment.

5. The method of claim 4, further comprising updating the neighbor cache table by monitoring neighbor discovery message activities.

6. The method of claim 3, wherein the neighbor solicitation messages to verify a veracity of the neighbor cache table independently of neighbor discovery timing.

7. The method of claim 1, further comprising upon detecting the change in the external environment requiring an administer to unlock the first host device to accept jobs and/or requests from the one or more second host devices.

8. The method of claim 1, wherein the network connection between the first host device and the one or more second host devices is an IPv4 network connection.

9. The method of claim 8, further comprising using ARP (address resolution protocol) messages to detect changes in the external environment.

10. The method of claim 1, wherein the network connection between the first host device and the one or more second host devices is an USB connection.

11. The method of claim 10, wherein the one or more second host devices is a computer having a printer driver, and wherein a PJL (printer job language) generated by the printer driver has a CPU specific ID (identifier), and if the first host device has seen the CPU specific ID, and a current CPU specific ID do not match, securing the first host device from processing jobs and/or requests from the one or more second host devices.

12. The method of claim 1, wherein the first host device is an image forming apparatus and the one or more second host devices is a computer device, and wherein the jobs and/or requests from the one or more second host devices are print jobs.

13. The method of claim 1, further comprising displaying a message on a graphical user interface of the first host device upon rejecting jobs and/or requests from the one or more second host devices to indicate that the one or more second host devices need to be reset and/or unlocked.

14. The method of claim 1, wherein the first host device is an image forming apparatus, and the one or more second host devices are an image forming apparatus, an intermediary device, a router, and/or a personal computer.

15. A system for physically securing a first host device from one or more second host devices, the system comprising:
a first host device, the first host device an application, which
creates a neighbor cache table for monitoring network connections between the first host device and the one or more second host devices;
monitors the external network connections between the first host device and the one or more second host devices; and
upon determining a change in an external environment between the first host device and the one or more second host devices, securing the first host device from processing jobs and/or requests from the one or more second host devices.

16. The system of claim 15, wherein the change in the external environment between the first host device and the one or more second host devices includes at least one of the following:
an unavailability of one or more of the one or more second host devices;
a change in one or more default routers;
a change in DHCP server or DNS server;
a change in a network prefix of one or more of the second host devices;
a change in an addressing method of one or more of the second host devices; or
a change of an IP address of the one or more second host devices.

17. The system of claim 15, wherein the network connection between the first host device and the one or more second host devices is an IPv6 network connection, and the application uses neighbor discovery to create the neighbor cache table and detect changes in the external environment and updates the neighbor cache table by monitoring neighbor discovery message activities.

18. The system of claim 17, wherein the network connection between the first host device and the one or more second host devices is an IPv4 network connection, and using ARP (address resolution protocol) messages to detect changes in the external environment.

19. The system of claim 15, wherein the network connection between the first host device and the one or more second host devices is an USB connection, and the one or more second host devices is a computer having a printer driver, and wherein a PJL (printer job language) generated by the printer driver has a CPU specific ID (identifier), and if the first host device has seen the CPU specific ID, and a current CPU specific ID do not match, securing the first host device from processing jobs and/or requests from the one or more second host devices.

20. A computer program product comprising a non-transitory computer usable medium having a computer readable code embodied therein for physically securing a first host device, the computer readable code configured to cause the first host device to execute a process for an application that physically secures the first host device, the process comprising:
initializing the first host device, the first host device having an application, which performs the following steps:
creates a neighbor cache table for monitoring a network connection between the first host device and one or more second host devices;
monitors the external network connections between the first host device and the one or more second host devices; and
upon determining a change in an external environment between the first host device and the one or more second host devices, securing the first host device from processing jobs and/or requests from the one or more second host devices.

21. The computer program product of claim 20, wherein the change in the external environment between the first host device and the one or more second host devices includes at least one of the following:
an unavailability of one or more of the one or more second host devices;
a change in one or more default routers;
a change in DHCP server or DNS server;
a change in a network prefix of one or more of the second host devices;
a change in an addressing method of one or more of the second host devices; or
a change of an IP address of the one or more second host devices.

22. The computer program product of claim 21, wherein the network connection between the first host device and the one or more second host devices is an IPv6 network connection.

23. The computer program product of claim 22, further comprising using neighbor discovery to create the neighbor cache table and detect changes in the external environment.
